(19) United States
(12) Patent Application Publication
(10) Pub. No.: US 2021/0303737 A1
(43) Pub. Date: Sep. 30, 2021

(54) Enhanced User Privacy of Sensitive Data on A User Data Input Display

(71) Applicant: QUALCOMM Incorporated, San Diego, CA (US)

(72) Inventors: Amit Pravin CHOUDHARI, Kalyan (IN); Basant Kumar, Jhumri Telaiya (IN); Rajesh Yadav, Hyderabad (IN)

(21) Appl. No.: 16/832,939

(22) Filed: Mar. 27, 2020

(51) Int. Cl. G06F 21/84; G06F 3/16; G06F 3/0488; G06F 3/0482

(52) U.S. Cl. CPC G06F 21/84; G06F 3/16; G06F 2203/04803; G06F 3/0482; G06F 3/04886

(57) ABSTRACT

Methods implemented on computing devices provide protections for sensitive information by outputting audio descriptions of sensitive information via a personal audio output device coupled to the computing device so that the description can be heard only by the user rather than displaying the information. Further protections for sensitive information may include displaying an input keypad on a touch-sensitive display in which key images do not include a visual indication of the character or value associated with each key, and outputting an audio description of the character or value associated with a user-selected key of the keys on the data input keypad via the personal audio output device so that the key description can be heard only by the user. Key audio descriptions may be output in response to a first keypad input, and a data entry may be processed in response to a second keypad input on the same key

### BACKGROUND

Modern computing devices encrypt and otherwise secure sensitive data received electronically or stored therein, but the act of viewing such data or manually entering sensitive data into the computing device by a user may not be very secure. For example, if a user accesses a bank account on a mobile computing device (e.g., a smartphone), the user's bank balance may be displayed where it can be viewed by other people or by nearby surveillance cameras. As another example, when a user manually enters a password, security code, pin, or other sensitive data into a computing device using a keypad, although the display may not show what was entered by the user, observing which keys were pressed by the user on the keypad will reveal what the user has entered. In this way, sensitive data may be compromised by nearby observers or video surveillance devices in public locations. The compromise of sensitive data during display and/or manual input by a user may occur when using mobile computing devices, like cellphone, laptops, or tablets, but may also occur when using an automated teller machines (ATM), keypad locks, or other sensitive data entry environments.

### SUMMARY

Various aspects include methods and computing devices implementing the methods for enhancing user privacy of sensitive data on a touch-sensitive display of a computing device. Various aspect methods may be implemented on a computing device having a touch-sensitive display, an audio output interface configured to output audio signals to a personal audio output device, a memory, and a processor coupled to the touch-sensitive display, the audio output interface, and the memory, in which the processor may be configured with processor-executable instructions to perform operations of the various aspect methods. Various aspects may include receiving information for display from an information source or memory whether at least a portion of the received information is sensitive information and whether sensitive information should not be displayed, and outputting an audio description of sensitive information via a personal audio output device communicatively coupled to the computing device in response to determining that at least a portion of the received information is sensitive and should not be displayed, wherein output of the audio description of the sensitive information is configured to be heard only by a user. In some aspects, determining whether at least a portion of the received information is sensitive information and whether sensitive information should not be displayed may include determining whether at least a portion of the received information is sensitive information based on one or more of a source of the received information, metadata associated with the received information, a context of the received information, or a content of the received information, and determining whether sensitive information should not be displayed is based on an environment in which the computing device is located. Some aspects may further include blocking display of sensitive information on the touch-sensitive display with a blank field or placeholder characters, and outputting the audio description of the sensitive information via the personal audio output device in response to a user touch on the blank field or placeholder characters.

Some aspects may further include displaying a data input keypad on the touch-sensitive display of the computing device in which keys on the data input keypad are displayed without a visual indication of a character or value associated with each key, and outputting an audio description of the character or value associated with a user-selected key on the data input keypad via the personal audio output device communicatively coupled to the computing device, in which output of the audio description of the character or value associated with the user-selected key may be configured to be heard only by the user.

Some aspects may further include detecting a user interaction with the data input keypad indicating the user-selected key, and determining whether the user interaction with the data input keypad indicating the user-selected key used a first key selection technique or a second key selection technique different from the first key selection technique. In such aspects, outputting the audio description of the character or value associated with the user-selected key may be performed in response to determining that the user interaction with the data input keypad indicating the user-selected key used the first key selection technique.

Some aspects may further include receiving in the processor as a data input the character or value associated with the user-selected key in response to determining that the user interaction with the data input keypad indicating the user-selected key used the second key selection technique. In some aspects, the first key selection technique may be a single-tap or touch of the user-selected key and the second key selection technique may be a double-tap or touch of the user-selected key. Some aspects may further include displaying a generic placeholder in a data entry display section of the touch-sensitive display in place of a visual representation of the character or value associated with the user-selected key in response to entering the character or value associated with the user-selected key, and displaying the generic placeholder may be performed in response to the user touching the user-selected key using an key selection technique configured to enter as an input selection the character or value associated with the user-selected key.

In some aspects, the output of the audio description of the character or value associated with the user-selected key may provide the only feedback of a value or character associated with the user-selected key. In some aspects, the output audio description of the character or value associated with the user-selected key may include an audio description of more than one character or value associated with the user-selected key. In some aspects, the output audio description of the character or value associated with the user-selected key may include an audio description of a range of character inputs.

Some aspects may further include randomly assigning a character or value associated with each key on the data input keypad each time the data input keypad may be displayed. Some aspects may further include assigning the character or value associated with each key on the data input keypad based on user inputs in a configuration process.

Some aspects may further include determining whether user privacy of sensitive data should be enhanced based on an environment in which the computing device may be located, and displaying the keys on the data input keypad without the visual indication of the character or value associated with each key in response to determining that user privacy of sensitive data should be enhanced. Some aspects may further include determining whether a current location of the computing device may be insecure for manual entry of sensitive data, and displaying the keys on the data input keypad without the visual indication of the character or value associated with each key in response to determining the current location of the computing device may be insecure for manual entry of sensitive data.

Further aspects may include a computing device having a touch-sensitive display, an audio output interface configured to output audio signals to a personal audio output device, a memory, and a processor configured to perform one or more operations of any of the methods summarized above. Further aspects may include a non-transitory processor-readable storage medium having stored thereon processor-executable instructions configured to cause a processor of a computing device to perform operations of any of the methods summarized above. Further aspects include a computing device having means for performing functions of any of the methods summarized above. Further aspects include a system on chip for use in a computing device that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a schematic diagram illustrating a user using a computing device with enhanced user privacy of sensitive data in accordance with various embodiments.

FIGS. 2A-2C are schematic diagrams illustrating various operating modes in accordance with various embodiments.

FIG. 3 is a block diagram illustrating components of an example system in a package for use in a computing device configured to provide enhanced user privacy of sensitive data in accordance with various embodiments.

FIG. 4 is a component block diagram illustrating a system configured for enhancing user privacy of sensitive data on a touch-sensitive display of a computing device in accordance with various embodiments.

FIGS. 5A, 5B, 5C, 6A, 6B, 6C, 6D, 6E, and/or 6F illustrate(s) operations of methods for enhancing user privacy of sensitive data on a touch-sensitive display of a computing device in accordance with various embodiments.

FIG. 7 illustrates operations of a method for enhancing user privacy of sensitive data on a user data output display of a computing device in accordance with some embodiments.

FIG. 8 is a component block diagram of a computing device in the form of a wireless communication device suitable for enhancing user privacy of sensitive data on a touch-sensitive display of a computing device in accordance with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments provide enhanced security for users of electronic devices by using a personal audio device to relay sensitive information to a user while obfuscating or not presenting the information on a display that could be viewed by other people or cameras. Various embodiments may include receiving information for display to a user from an information source (e.g., a bank, credit card service, doctor, etc.) or memory, determining whether the information is personal or sensitive information (e.g., account balances, account numbers, social security numbers, etc.), and generating an audio output of the information via a personal audio device (e.g., earphones) without displaying the information on a display screen. In some embodiments, sensitive user data (e.g., account balance values) in a user data output display may be hidden with a blank field or placeholder characters (e.g., “XXXXX”) and the audio indication of the associated value may be played in the user's personal audio device in response to a user selection of (e.g., a touch or tap on) the blank field or placeholder characters.

Further protections for user sensitive information, such as under names and passwords, social security numbers, personal identify numbers (PIN), telephone numbers, addresses, etc. are provided in some embodiments by preventing other people or cameras from learning such information by watching or videotaping the user entering the information on a data entry display of a touch screen interface. Such embodiments may include hiding the character or value assigned or associated with keys on a user input display and providing an audio indication of the assigned or associated value for a key in response to a user selection of a particular key, in which the audio indication is provided via an earpiece or similar private audio device. Once the user indicates by a particular input that the key with the value provided in the audio indication should be entered, the processor enters that value. Key indications in the display may be blank or may be different from the character or value assigned or associated with the keys.

As used herein, the term “computing device” refers to an electronic device equipped with at least a processor. Computing devices may include wireless communication devices, personal computers, ATM's, and other devices with computer processing capabilities that include a user data input display. For example, computing devices may include any one or all of wireless appliances, cellular telephones, smartphones, portable computing devices, personal or mobile multi-media players, laptop computers, tablet computers, 2-in-1 laptop/table computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor. In various embodiments, computing devices may be configured with memory and/or storage. Additionally, computing devices referred to in various example embodiments may be coupled to or include wired or wireless communication capabilities implementing various embodiments, such as network transceiver(s) and antenna(s) configured to establish a local area network (LAN) connection (e.g., Wi-Fi® or Bluetooth transceivers).

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

The term “multicore processor” may be used herein to refer to a single integrated circuit (IC) chip or chip package that contains two or more independent processing cores (e.g., CPU core, Internet protocol (IP) core, graphics processor unit (GPU) core, etc.) configured to read and execute program instructions. A SOC may include multiple multicore processors, and each processor in an SOC may be referred to as a core. The term “multiprocessor” may be used herein to refer to a system or device that includes two or more processing units configured to read and execute program instructions.

Various embodiments enhance user privacy of sensitive data on a user data input display rendered on a touch-sensitive display of a computing device. A processor may determine that the received information based on a source of the information (e.g., a bank or doctor's office), metadata included with the information (e.g., a security code), a user indication or selection, a match to information stored with an indication of sensitivity, or characteristics of the data (e.g., a number format consistent with a social security number or phone number). An audio file may be generated based on the sensitive information, such as using a text-to-synthetic speech application. In some embodiments, a data output portion of the display in locations where sensitive information would be displayed may be configured to avoid displaying the sensitive or private information (e.g., user name, user address, account numbers, account balances, etc.) by covering or replacing the information with a blank field 160 or placeholder characters, such as a series of characters (e.g., X, *, @, #, $, etc.) In response to the user touching, tapping or otherwise selecting a blank field 160 or a placeholder characters, the user may hear an announcement of the sensitive or private information (such as an account balance value) through the personal audio output device 150.

Some embodiments may provide protections for users entering sensitive information on a touch screen display, but shuffling key designations without visible indications while enabling a user to learn the character or value associated with a key through a personal audio device. Such embodiments may include displaying an input keypad on the user data input display in which keys on the data input keypad do not include a visual indication of the character or value associated with each key. Also, an audio description of the character or value associated with a user-selected key of the keys on the data input keypad may be output via a personal audio output device communicatively coupled to the computing device. The output of the audio description of the character or value associated with the user-selected key may be configured to be heard only by the user.

Normally input keys are plainly labeled with one or more numbers, letters, characters or other symbols. Those numbers, letters, characters or other symbols generally denote the character or value associated with each key. A problem created by conventional input mechanisms is that when a user touches a conventional input key that is plainly labeled, an observer can see what key was pressed, making such input methods insecure, particularly in public places.

In various embodiments, the privacy of sensitive data entered into a computing device may be enhanced by masking or concealing the character or value assigned to or associated with the input keys used to enter that sensitive data. To address this problem, various embodiments provide data input displays of input keypads which the displayed keys do not include a visual indication of the character or value associated with each key and the user is informed of the character or value associated with each key audibly via earphones, earbuds, etc. Thus, observers cannot know from visual observation the value, character, function, or operation that is associated with each key, and thus cannot discover the user's data by observing the keys touched by a user. The user alone learns the assigned character or value of each key through an audio description provided from a personal audio output device, secure from observers. Thus, when the user selects a particular key using a first key selection technique (e.g., a single tap, light touch, prolonged touch, hovering over the key, etc.), the user will hear an announced description of the character or value associated with the user-selected key through the personal audio output device. By selecting that key again or selecting that key using an alternate key selection technique (e.g., double-tap, a firm touch, a brief touch following the prolonged touch of the first technique, touching the key after hovering over the key, tapping the key while also tapping another key or part of the display, etc.), the user may cause the processor of the computing device to receive or enter the value or character as a data input. The user may then repeat the process to enter additional characters or values of sensitive data. Thus, various embodiments provide improved user security over conventional data entry user interfaces by protecting against observers determining sensitive data entered into a computing device by observing the keys that are pressed.

The processor may be configured to recognize when the user interacts with a data input keypad using a first key selection technique, and in response output the audio description of the character or value associated with the user-selected key without entering the character or value associated with the user-selected key. The processor may be configured to recognize when the user interacts with a data input keypad using a second key selection technique different from the first key selection technique, and in response receive or enter the character or value associated with the user-selected key as a data input. The first and second key selection techniques may be any form of user interaction that the processor can recognize and distinguish. For example, the first key selection technique may include a single-tap of the user-selected key and the second key selection technique may include a double-tap of the user-selected key. Other examples of first key selection techniques may include a light touch, prolonged touch, hovering over the key, touching with a finger instead of a stylus, and touching the key without touching another place on the touch sensitive display. Other examples of second key selection techniques may include a firm touch, a brief touch following the prolonged touch of the first technique, touching the key after hovering over the key, and tapping the key while also tapping another key or part of the touch sensitive display.

Some embodiments may include displaying a generic placeholder, such as a blank field or generic characters (e.g., X, *, #, $, @, etc.) in a data entry display section of the touch-sensitive display in place of a visual representation corresponding to the character or value associated with the user-selected key. The generic placeholder may not reveal a visual indication of the character or value associated with the user-selected key to an observer of the display. The processor may be configured display the generic placeholder in response to the user touching the user-selected key using the second key selection technique as a visual indication that the processor has entered the character or value associated with the user-selected key. The processor may not display the generic placeholder when outputting the audio description of the use-selected key in response to recognizing the first key selection technique.

In some embodiments, the output audio description of the character or value associated with the user-selected key may provide the only feedback as to the character or value assigned to or associated with the user-selected key. The output audio description of the character or value assigned to or associated with the user-selected key may include an audio description of more than one character or value. The output audio description of the character or value assigned to or associated with the user-selected key may include an audio description of a range of character or value inputs.

In some embodiments, the character or value assigned to or associated with each of the keys may be randomly assigned, and may change each time the user accesses the data entry display. In this manner, the user's sensitive information may not be discovered by viewing multiple data entries and decoding the key-value associations. On the other hand, the character or value assigned to or associated with each of the keys may be user assigned, such as during a user configuration procedure. In some embodiments, the personal audio output device may be worn on the user's ear.

Some embodiments may include determining whether user privacy of sensitive data should be enhanced based on an environment in which the computing device is located. Displaying the keys on the data input keypad without the visual indication of the character or value associated with each key may be in response to determining that user privacy of sensitive data should be enhanced. Some embodiments may include determining whether a current location of the computing device is insecure for manual entry of sensitive data. Displaying the keys on the data input keypad without the visual indication of the character or value associated with each key may be in response to determining the current location of the computing device is insecure for manual entry of sensitive data.

Various embodiments provide enhanced security for sensitive information of user of computing devices by using a personal audio device to output an audible description of sensitive information instead of displaying the information. Some embodiments further protect sensitive information, such as passwords by shuffling the values or characters associated with keys in a keypad on a touch sensitive display and conveying the value/character to a user through the personal audio device when touched. Thus, the various embodiments improve the user experience with computing devices by providing easy to use methods for preventing cameras or bystanders from viewing sensitive information on a display or recording the entry of sensitive information in a displayed keypad.

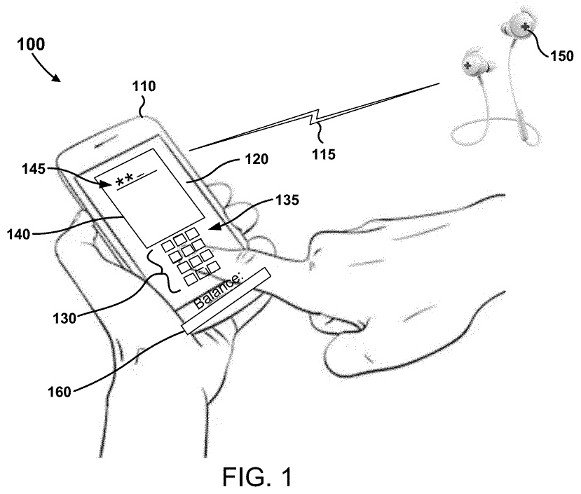

FIG. 1 illustrates an example of an environment 100 that is suitable for implementing various embodiments. The environment 100 includes a user 5 entering sensitive data on a touch-sensitive display 120 of a computing device 110. The computing device 110 is communicatively coupled to a personal audio output device 150. Typically, the personal audio output device 150 is worn by the user 5 in order to ensure that the output from the personal audio output device 150 is configured to be heard only by the user 5.

Although various embodiments may enhance user privacy of sensitive data in environments that are insecure, the methods, devices, and systems described herein may also be used in secure environments. Insecure environments include surroundings in which privacy of sensitive data being entered into a computing device is not secure, unsafe, not adequately guarded, or otherwise visually exposed to others (i.e., directly and/or through video recording/transmission devices). For example, public or other spaces in which other people may stand or get close enough to the user 5 to be able to observe the touch-sensitive display 120 are insecure environments. Also, public or common areas that include devices, like ATM's or keypad entry locks, into which sensitive data is input by users may also constitute insecure environments.

In accordance with various embodiments, the touch-sensitive display 120 may be a touch-screen display for displaying text, data, information, images, etc. and receiving user inputs through touch interactions with icons or images (e.g., images of a key) presented on the touch-sensitive display. In some embodiments, the touch-sensitive display section may be configured to display an input section 130 that includes an input keypad 135 with a plurality of keys for manually entering data inputs. The data input keypad 135 may be a visual representation of a keypad, rather than actual physical buttons. The touch-sensitive display 120 may be configured to display a data entry display section 140 for displaying information, including characters or symbols that represent when a character or value has been entered by the user interacting with the data input keypad using the second key selection technique. In addition, the display 120 may include a data output portion 160 for displaying placeholder characters in place of sensitive user information, such as account number, account balance, user name, etc.

In various embodiments, a data output portion of the display in locations where sensitive information would be displayed may be configured to avoid displaying the sensitive or private information (e.g., user name, user address, account numbers, account balances, etc.) by covering or replacing the information with a blank field 160 or placeholder characters, such as a series of characters (e.g., X, *, @, #, $, etc.) In response to the user touching, tapping or otherwise selecting a blank field 160 or a placeholder characters, the user may hear an announcement of the sensitive or private information (such as an account balance value) through the personal audio output device 150.

In some embodiments, the computing device 110 may be configured to display a data input keypad 135 on a touch sensitive display, such as in the input display section 130, that does not include a visual indication of the character or value associated with each key. For example, the keys of the data input keypad 135 may include blank key icons or display one or more placeholder characters or symbols unrelated to the character or value associated with each key. Each of the keys will be assigned a character or value or may execute a function (e.g., a macro or other multistep process), but the assigned character or value of each key is not revealed by its appearance in the input section 130 or any other portion of the touch-sensitive display 120.

In various embodiments, the user 5 may be informed or reminded of a key's assignment by interacting with the image of that key in the input section 130 using the first key selection technique (e.g., tapping, touching or hovering over). In other words, the processor of the computing device may be configured to respond to a first key selection technique (e.g., single-tap) by playing the audio description of the character input played in the personal audio output device 150 without entering a character or value associated with the user selected key.

Selecting or interacting with the same key using a second key selection technique, such as double tapping the key, etc., the processor may enter the character or value associated with the key as a data input into an application of web browser interface. The processor of a computing device may also be configured to respond to the second key selection technique (e.g., double-tap) by displaying a generic placeholder 145 (e.g., a blank field or generic characters like X, *, #, $, @, etc.) on the touch-sensitive display 120.

The user 5 may then repeat this process for the input of additional sensitive data. In some embodiments, the output of the audio description of the key's assignment from the personal audio output device 150 may be the only way the user 5 can discover the character or value assigned to or associated with any particular input key 135, at least while the processor is operating in the enhanced security mode. In the case of headphones, an earpiece, ear buds, or similar devices, the personal audio output device 150 may be worn on or in the user's ears.

In various embodiments, the computing device 110 may include one or more radio signal transceivers and antennae, coupled to each other and/or to a processor, for sending and receiving wireless signals 115 using one or more wireless communication protocols (e.g., Peanut®, Bluetooth®, Zigbee®, Wi-Fi, RF radio). The radio signal transceivers and antennae may be used to transmit wireless signals 115 to peripheral devices, such as the personal audio output device 150, for outputting the audio description of the sensitive data character input into the computing device 110. In addition, or alternatively, the computing device 110 may include an audio or other port for coupling to a personal audio output device using a wired connection. Thus, the personal audio output device 150 may be communicatively coupled to the computing device using a wired and/or wireless connection.

In various embodiments, the data entry display section 140 may be configured to display one or more generic placeholders 145 in place of a visual representation corresponding to the character or value associated with any particular user-selected key. In FIG. 1, two generic placeholders 145 are illustrated as asterisk symbols (**). The generic placeholders 145 may each be almost any symbol or character, as long as they do not reveal the value of the sensitive data character input they represent to an observer of the touch-sensitive display 120. Multiple generic placeholders 145 may be the same or different symbols or characters. In this way, other individuals who look at the touch-sensitive display 120 should be unable to decipher the values of the sensitive data represented by the generic placeholders 145. In various embodiments, the user 5 himself/herself may be unable to decipher the values of the sensitive data from the generic placeholders 145 alone. In some embodiments, the user may learn the value associated with generic placeholders 145 by touching them and listening to an audio announcement of the associated values via the personal audio output device 150.

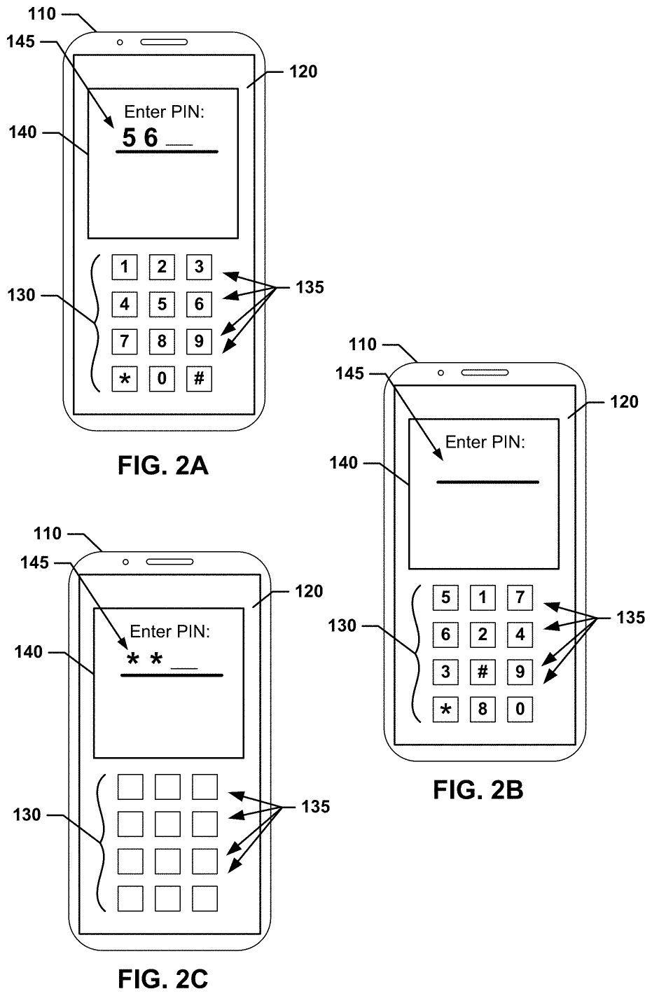

Various embodiments may assign the value to each key of the data input keypad by various methods. FIGS. 2A-2C illustrate a computing device 110 in two different operating modes to illustrate aspects of the data input keypad 135, what inputs may be associated with the keys and how those inputs may be assigned in accordance with various embodiments.

With reference to FIGS. 1-2C, the computing device 110 may be configured to switch between a conventional operation mode and an enhanced user privacy mode for sensitive data entry. FIG. 2A illustrates the computing device 110 in the conventional operation mode, such that the touch-sensitive display 120 displays a conventional keypad in the input section 130 with each key 135 labeled and a more conventional data entry display section 140 that does not mask or conceal data character inputs (i.e., “5” and “6”) that have already been entered. In this way input selections that have been entered are plain to see on the display.

In contrast, FIG. 2B illustrates the computing device 110 being programmed for an enhanced user privacy mode for sensitive data entry, which may be considered a programming mode. During the programming mode, the user (e.g., user 5) may be allowed to see visual indications of the character or value associated with each key.

The assignment of the value of each key of the data input keypad 135 may be programmed by the user ahead of time via a series of user inputs in a configuration process. By allowing the user to visualize the character or value associated with each key in the programming mode, the user may memorize the key assignments in order to know how to enter data correctly using the customized input keypad 135 with no visual indication as to the character or value associated with each key. The user may use a random method of assignment, a pattern (i.e., one that is easy to remember), or even assign the keys in a conventional pattern. Alternatively, the key assignments may be generated by a processor of the computing device 110, which may assign characters or values to keys in a random manner, and may change the character value assignments each time the user accesses an application that generates the data input keypad 135. In this manner, the user's sensitive information may not be discovered by viewing multiple data entries and decoding the key-to-character or value associations. In either the user-assigned or processor-assigned methods, in response to the user activating a programming mode, the key character/value assignments may be displayed so that the user can view the assigned key characters and values. In various embodiments, the user may be allowed to activate the programming mode at any time (e.g., using a security measure) to be visually reminded of the key assignments.

FIG. 2C illustrates the computing device 110 in the enhanced user privacy mode for sensitive data entry. As shown, the input section 130 displays a data input keypad 135, but the keys do not include a visual indication of the character or value associated with each key. The keys of the data input keypad 135 may be blank or display one or more characters or symbols unrelated to the character or value associated with each key. Each of the keys is associated with a character or value or may execute operations or a function (e.g., a macro or other multistep process), but the assigned or associated character/value of each key is not revealed by its appearance in the input section 130 or any other portion of the touch-sensitive display 120. In addition, in the enhanced user privacy mode the data entry display section 140 may be configured to display one or more placeholder characters 145 in place of a visual representation corresponding to the character or value associated with any particular user-selected key.

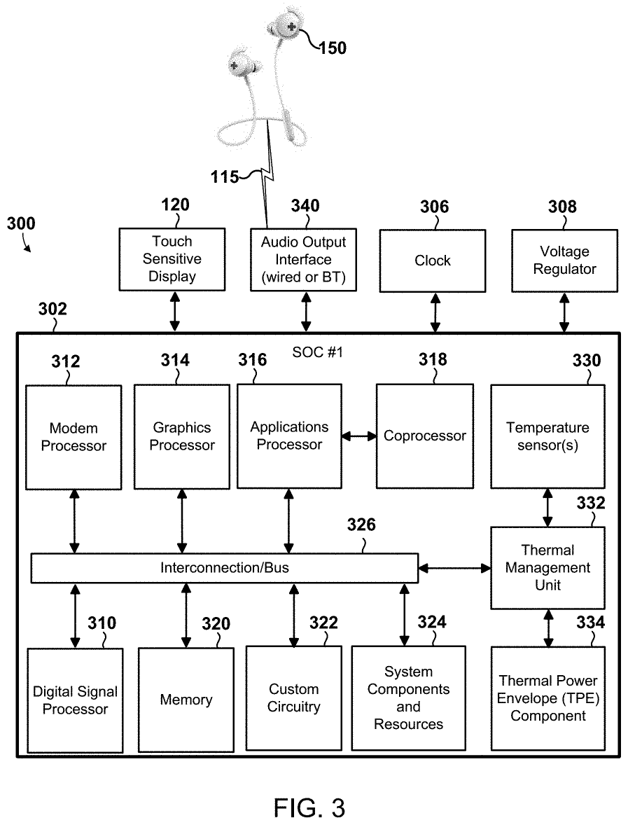

Various embodiments may be implemented on a number of single processor and multiprocessor computer systems, including a system-on-chip (SOC) or system in a package (SIP). FIG. 3 illustrates an example computing system or SIP 300 architecture that may be used in wireless devices implementing the various embodiments.

With reference to FIGS. 1-3, the illustrated example SIP 300 includes a SOC 302, a clock 306, and a voltage regulator 308. In some embodiments, the SOC 302 operate as central processing unit (CPU) of the wireless device that carries out the instructions of software application programs by performing the arithmetic, logical, control and input/output (I/O) operations specified by the instructions.

The SOC 302 may include a digital signal processor (DSP) 310, a modem processor 312, a graphics processor 314, an application processor 316, one or more coprocessors 318 (e.g., vector co-processor) connected to one or more of the processors, memory 320, custom circuitry 322, system components and resources 324, an interconnection/bus module 326, one or more temperature sensors 330, a thermal management unit 332, and a thermal power envelope (TPE) component 334 and other components, such as transceivers or antennae.

Each processor 310, 312, 314, 316, 318, may include one or more cores, and each processor/core may perform operations independent of the other processors/cores. For example, the SOC 302 may include a processor that executes a first type of operating system (e.g., FreeBSD, LINUX, OS X, etc.) and a processor that executes a second type of operating system (e.g., MICROSOFT WINDOWS 10). In addition, any or all of the processors 310, 312, 314, 316, 318 may be included as part of a processor cluster architecture (e.g., a synchronous processor cluster architecture, an asynchronous or heterogeneous processor cluster architecture, etc.).

The SOC 302 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 324 of the SOC 302 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 324 and/or custom circuitry 322 may also include circuitry to interface with peripheral devices, such as cameras, electronic displays, wireless communication devices, external memory chips, etc.

The various processors 310, 312, 314, 316, 318, may be interconnected to one or more memory elements 320, system components and resources 324, and custom circuitry 322, and a thermal management unit 332 via an interconnection/bus module 326. The interconnection/bus module 326 may include an array of reconfigurable logic gates and/or implement a bus architecture (e.g., CoreConnect, AMBA, etc.). Communications may be provided by advanced interconnects, such as high-performance networks-on chip (NoCs).

The SOC 302 may further include an input/output module (not illustrated) for communicating with resources external to the SOC, such as a clock 306, a voltage regulator 308, an audio output interface 340, such as a socket for a headphone jack or a Bluetooth transceiver configured to output audio signals (e.g., wireless signals 115) to a personal audio output device 150, a touch sensitive display 120, and other peripheral devices and external resources. Resources external to the SOC (e.g., clock 306, voltage regulator 308) may be shared by two or more of the internal SOC processors/cores.

In addition to the example SIP 300 discussed above, various embodiments may be implemented in a wide variety of computing systems, which may include a single processor, multiple processors, multicore processors, or any combination thereof

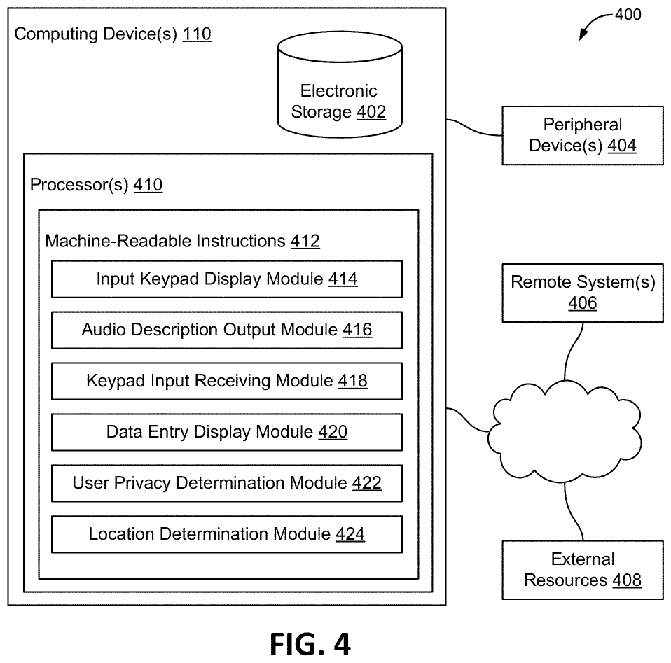

FIG. 4 is a component block diagram illustrating a system 400 configured for enhancing user privacy of sensitive data on a touch-sensitive display of a computing device in accordance with various embodiments. In some embodiments, system 400 may include one or more computing devices 110 and/or one or more remote systems 406. With reference to FIGS. 1-4, computing device (s) 110 may be communicatively coupled to peripheral device (e.g., personal audio output device 150), as well as remote system(s) 406 and/or external resources 408.

Computing device(s) 110 may be configured by machine-readable instructions 412. Machine-readable instructions 412 may include one or more instruction modules. The instruction modules may include computer program modules. The instruction modules may include one or more of input keypad display module 414, audio description output module 416, keypad input receiving module 418, data entry display module 420, user privacy determination module 422, location determination module 424, and/or other instruction modules.

The data input keypad display module 414 may be configured to display an input keypad on the user data input display. Keys on the displayed input keypad may not include a visual indication of the character or value associated with each key. The value or character input associated with each of the keys may be randomly assigned, and may change each time the user accesses the data entry display. Alternatively, the assigned or associated value of each of the keys may be user-determined via a series of user inputs in a configuration process.

The audio description output module 416 may be configured to output an audio description of the character or value associated with a user-selected key of the keys on the data input keypad displayed by the data input keypad display module 414. The audio description output module 416 may use a text-to-speech or text-to-audio application that converts text or other recorded elements (including letter, numbers, symbols, words, phrases, etc.) into an audible speech equivalent that describes the elements.

The audio description output module 416 may output the audio description via a personal audio output device communicatively coupled to the computing device. The output of the audio description of the character or value associated with the user-selected key may configured to be heard only by the user, such as through an audio output device work on the user's ear(s). Also, the output of the audio description of the character or value associated with the user-selected key may provide the only feedback as to the assigned or associated value of the user-selected key.

In some embodiments, the audio description output module 416 may be configured to output an audio description of the character or value associated with a user-selected key, where the user-selected key is associated with more than one character input. In this way, the audio description that is output would describe the plurality of character inputs. For example, if one key is associated with the letters “A,” “B,” and “C,” the output audio description may recite, “A, B, and C.” Alternatively, the output audio description may recite a range of character inputs, such as “A through C.”

The keypad input receiving module 418 may be configured to receive keypad inputs from each key of the plurality of keys on the user data input display. The keypad input receiving module 418 may be configured to recognize more than one key selection technique. Different key selection techniques may be used for different purposes. A first key selection technique may be configured to output the audio description of the character or value associated with the user-selected key but not to enter the first keypad input as an input selection. This type of first key selection technique may be helpful to remind the user the character or value associated with a particular key, but without the user entering the value in an input field. In contrast, a second keypad key selection technique, different from the first key selection technique, may be configured to enter the second keypad input as data entry selection. For example, the first key selection technique may include a single-tap of the key and the second key selection technique may include a double-tap of the key. Displaying the generic placeholder on the touch-sensitive display may be in response to receiving the second keypad input entered by the user using the second key selection technique, but not in response to receiving the second keypad input entered by the user using the first key selection technique.

In addition, other key selection techniques may be used when more than one input character is assigned to a single key. For example, a single-tap on a key image may reveal a first character assigned to that key (i.e., the character or number that will be entered when the key is activated in a first manner), a double-tap the same key image may reveal a second character assigned to that key (i.e., the character or number that will be entered when the key is activated in a second manner, such as in combination with a “shift” key press), and so on. In addition, a combination of keys may need to be pressed to actually enter a value or character as a data input to the computing device. For example, a double-tap to select the second value associated with a key, followed by a tap on a key associated with the “enter” function.

The data entry display module 420 may be configured to display a generic placeholder on the touch-sensitive display in place of as actual characters or data in the enhanced user privacy mode. The output audio description of the sensitive data character input may include an audio description of more than one character or value. The output audio description of the sensitive data character input may include an audio description of a range of characters or values associated with a key. The generic placeholder should not reveal the assigned or associated value of the sensitive data character input to an observer of the display.

A user privacy determination module 422 may be configured to determine whether user privacy of sensitive data should be enhanced based on an environment in which the computing device is located. Displaying the generic placeholder on the touch-sensitive display in place of the visual representation corresponding to the sensitive data character input may be performed in response to determining that user privacy of sensitive data should be enhanced. The determination of whether to enhance user privacy may be made following a user input directing the computing device to enter an enhanced user privacy mode. Alternatively, determination of whether to enhance user privacy may be made by the particular software application, browser, or web site being used to enter the sensitive data. As a further alternative, a processor may detect the presence of other individuals, such as detecting signals generated by a mobile phone or other computing device, which may suggest the presence of others, and thus a reason to enhance the protections of user sensitive data by implementing methods of various embodiments.

Location determination module 424 may be configured to determine a location of the computing device. Displaying the generic placeholder on the touch-sensitive display in place of the visual representation corresponding to the sensitive data character input may be in response to determining the location is insecure for user privacy of sensitive data. The determination whether to enhance user privacy may be made based on location using GPS, a wireless hotspot ID (e.g., home vs. public), a cell ID, or other available signals that may provide information about the location of the computing device and whether that location is secure.

The computing device(s) 110 may include electronic storage 402, peripheral device(s) 404, one or more processors 410, and/or other components. Computing device(s) 110 may include communication lines, or ports to enable the exchange of information with the peripheral device(s) 404, a network and/or other computing systems. Illustration of computing device(s) 110 in FIG. 4 is not intended to be limiting. Computing device(s) 110 may include a plurality of hardware, software, and/or firmware components operating together to provide the functionality attributed herein to computing device(s) 110. For example, computing device(s) 110 may be implemented by a cloud of vehicle computing systems operating together as computing device(s) 110.

Electronic storage 402 may include non-transitory storage media that electronically stores information. The electronic storage media of electronic storage 402 may include one or both of system storage that is provided integrally (i.e., substantially non-removable) with computing device(s) 110 and/or removable storage that is removably connectable to computing device(s) 110 via, for example, a port (e.g., a universal serial bus (USB) port, a firewire port, etc.) or a drive (e.g., a disk drive, etc.). Electronic storage 402 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., FLASH drive, etc.), and/or other electronically readable storage media. Electronic storage 402 may include one or more virtual storage resources (e.g., cloud storage, a virtual private network, and/or other virtual storage resources). Electronic storage 402 may store software algorithms, information determined by processor(s) 410, information received from computing device(s) 110, information received from other vehicle computing system(s) 404, and/or other information that enables computing device(s) 110 to function as described herein.

The peripheral device(s) 404 may be any external device that provides input and/or output for the computing device(s) 110. Some peripheral device(s) 404 may be both input and output devices, while others may provide either input or output. A remote microphone, keyboard, or mouse are examples of an input peripheral devices, while a monitor, printer, or personal audio output device are examples of output peripheral devices. Some peripheral devices, such as personal audio output devices or external hard drives, provide both input and output. For example, some personal audio devices like headphones, earpieces, ear buds, or similar devices include both speakers and microphones, making them both input and output devices. As used herein, a personal audio output device is a peripheral device(s) that includes at least the output functionality (i.e., a speaker), but may also include input functionality (i.e., a microphone).

The peripheral device(s) 404 and/or remote system(s) 406 may each also include one or more processors configured to execute computer program modules configured by machine-readable instructions, such as the machine-readable instructions 412.

External resources 408 may include sources of information outside of system 400, external entities participating with the system 400, and/or other resources. For example, external resource 408 may include computing devices associated with financial institutions, government agencies, public or private companies, and other entities. In some embodiments, some or all of the functionality attributed herein to external resources 408 may be provided by resources included in system 400.

In some embodiments, computing device(s) 110, peripheral device(s) 404, remote system(s) 406, and other external resources 408 may communicate with one another via wired or wireless networks. Additionally, the computing device(s) 110, peripheral device(s) 404, and/or remote system(s) 406 may be connected to wireless communication networks that provide access to external resources 408. For example, such electronic communication links may be established, at least in part, via a network such as the Internet and/or other networks. It will be appreciated that this is not intended to be limiting, and that the scope of this disclosure includes embodiments in which computing device(s) 110, peripheral device(s) 404, remote system(s) 406, and/or other external resources 408 may be operatively linked via some other communication media.

Processor(s) 410 may be configured to provide information processing capabilities in computing device(s) 110. As such, processor(s) 410 may include one or more of a digital processor, an analog processor, a digital circuit designed to process information, an analog circuit designed to process information, a state machine, and/or other mechanisms for electronically processing information. Although processor(s) 410 is shown in FIG. 4 as a single entity, this is for illustrative purposes only. In some embodiments, processor(s) 410 may include a plurality of processing units. These processing units may be physically located within the same device, or processor(s) 410 may represent processing functionality of a plurality of devices operating in coordination. Processor(s) 410 may be configured to execute modules 414, 416, 418, 420, 422, and/or 424, and/or other modules. Processor(s) 410 may be configured to execute modules 414, 416, 418, 420, 422, and/or 424, and/or other modules by software; hardware; firmware; some combination of software, hardware, and/or firmware; and/or other mechanisms for configuring processing capabilities on processor(s) 410. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 414, 416, 418, 420, 422, and/or 424 are illustrated in FIG. 4 as being implemented within a single processing unit, in embodiments in which processor(s) 410 includes multiple processing units, one or more of modules 414, 416, 418, 420, 422, and/or 424 may be implemented remotely from the other modules. The description of the functionality provided by the different modules 414, 416, 418, 420, 422, and/or 424 described below is for illustrative purposes, and is not intended to be limiting, as any of modules 414, 416, 418, 420, 422, and/or 424 may provide more or less functionality than is described. For example, one or more of modules 414, 416, 418, 420, 422, and/or 424 may be eliminated, and some or all of its functionality may be provided by other ones of modules 414, 416, 418, 420, 422, and/or 424. As another example, processor(s) 410 may be configured to execute one or more additional modules that may perform some or all of the functionality attributed below to one of modules 414, 416, 418, 420, 422, and/or 424.

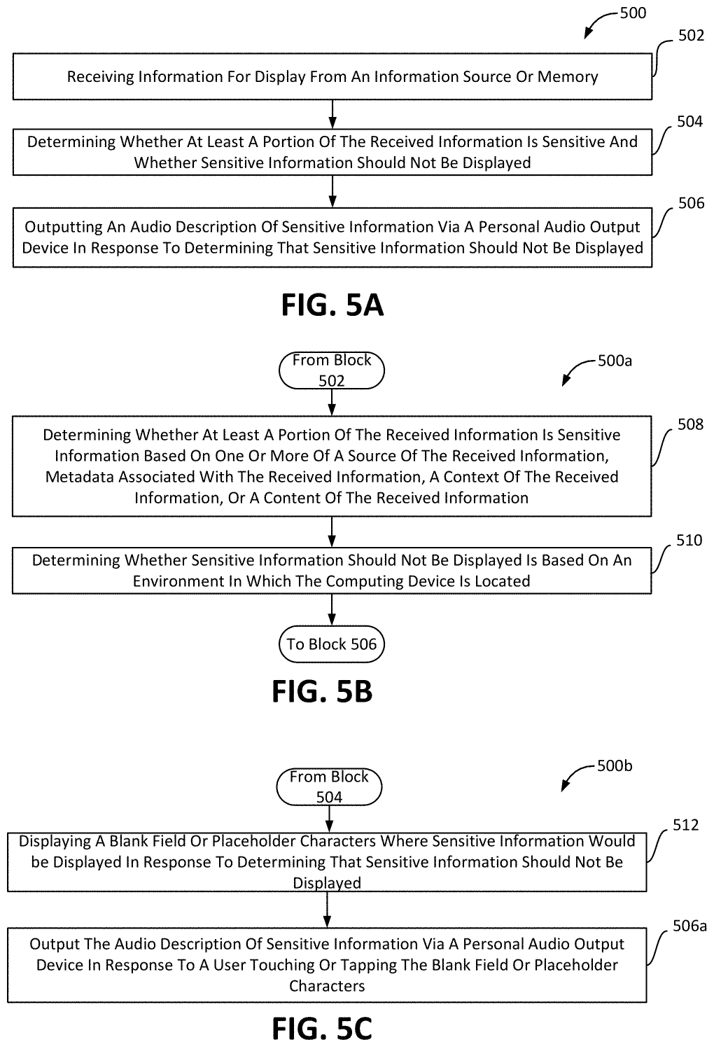

FIG. 5A illustrates operations of a method 500 for enhancing user privacy of sensitive data displayed on a computing device in accordance with various embodiments. FIG. 5B illustrates further details of operations that may be performed as part of the method 500. FIG. 5C illustrates further operations that may be performed in the method 500. The operations of the method 500 presented below are intended to be illustrative. In some embodiments, the method 500 may be accomplished with one or more additional operations not described, and/or without one or more of the operations discussed. Additionally, the order in which the operations of the method 500 are illustrated in FIGS. 5A, 5B and 5C and described below is not intended to be limiting.

In various embodiments, the method 500 may be implemented in a processor (e.g., 302, 312, 314, 316, 318, 410) in a computing device (e.g., 110) operating in conjunction with a touch sensitive display (e.g., 120) and a personal audio device (e.g., 150) via an audio output interface (e.g., 340).

Referring to FIG. 5A, in block 502, the processor may perform operations including receiving information for display on the computing device from an information source or memory. Non-limiting examples of information sources include remote servers of associated that may be accessed via a communication network (e.g., the Internet), servers on a local area network, and peripheral devices. Example of memory include internal memory, secure memory within or coupled to the processor, and peripheral memory devices.

For example, a user of the computing device may access a bank account server via a network (e.g., a wireless communication network coupled to the Internet) using a banking application executing on the computing device by entering a user name and password. Upon accessing the user's bank account, the user may input a request or the application may automatically request an account balance (e.g., a savings account balance, a checking account balance, a credit card balance, etc.). In response the bank account server may transmit the requested information to the computing device for display. In this example, the user's account number and the account balance information would be sensitive to the user, while a web page or other display generated by the bank server or by the banking application would not be sensitive.

As another example, the user may access sensitive information stored in memory of the computing device, such as within a secure memory portion, such as passwords (e.g., via a password aggregating application), credit card numbers (e.g., a digital wallet application), cryptocurrency balance (e.g., via a cryptocurrency wallet application).

In block 504, the processor may perform operations including determining whether at least a portion the information received from the information source or memory is sensitive information and whether sensitive information should not be displayed. As described with reference to FIG. 5B, the processor may determine whether the received information based on a number of factors, including the source of the information and/or the content of the information. For example, if an account balance is received from a bank server, the processor may determine that the balance value is sensitive information. As another example, if the information received in block 502 is from memory and obtained through an application that secures sensitive information (e.g., a password aggregator or digital wallet), the processor may determine that all of the information is sensitive information. Also as described with reference to FIG. 5B, the processor may determine whether sensitive information should not be displayed may be determined by the environment or location in which the computing device is located when the information is received. For example, the processor may access a location tracking application (e.g., a map application) to determine whether the computing device is located in a public space, and determine that sensitive information should not be displayed in response to the computing device being located in a public space. As another example, the processor may determine that sensitive information should not be displayed upon detecting a wireless access point (e.g., a WIFI hotspot) that is associated with a commercial establishment. As a further example, the processor may determine that sensitive information should not be displayed based upon a user entry, such as the user selecting a setting (e.g., on an application or in device settings) that sensitive information should not be displayed.

In block 506, the processor may perform operations including outputting an audio description of sensitive information via a personal audio output device (e.g., 140) communicatively coupled to the computing device in response to determining that at least a portion of the received information is sensitive and should not be displayed. For example, the processor may use a speech synthesizer application to convert the portion of the information received in block 502 that the processor determined to be sensitive information in block 504 into an audio clip that the processor directs to the personal audio output device (e.g., via an audio output interface 340). Any known speech synthesizer application may be used by the processor in block 506. The output of the audio description of the sensitive information may be configured to be heard only by the user wearing the personal audio output device. For example, the processor may control the volume of the audio output so that it cannot be overheard. As another example the processor may only output the audio description if the personal audio output device indicates to the processor that the device is being worn by a user. Returning to the banking example, the processor may output an audible rendering of the balance information.

FIG. 5B illustrates operations that may be performed by the processor in block 504 for of the method 500 in some embodiments.

In block 508, the processor may perform operations including determining whether at least a portion of the received information is sensitive information based on one or more of a source of the received information, metadata associated with the received information, a context of the received information, or a content of the received information. In many cases the source of information received by the processor in block 502 may establish whether the received information is sensitive. For example, if the information received in block 502 is from a bank or credit card server, a stock broker or investment fund server, a patient portal hosted by a medical provider, etc., the processor may determine that all received information is sensitive information. As another example, if the information is received via an application (e.g., a bank application) that provides an interface to a source of sensitive information (e.g., bank account information), the application may indicate the fields of information provided to the processor that contain sensitive information. As another example, information may be communicated and/or stored in memory with a metadata tag indicating whether the information is sensitive or not and the processor may evaluate such metadata to identify portions of the received information that is sensitive. As another example, the processor may perform an analysis on the received information to identify key words or other context parameters within the information that indicate or imply sensitive information, such as “balance,” “diagnosis,” etc. As a further example, the processor may recognize that numbers preceded or followed by a currency symbol are sensitive information.

In block 510, the processor may perform operations including determining whether sensitive information should not be displayed based on an environment in which the computing device is located. As mentioned above, the processor may use location information obtained from a navigation application, for example, to determine that sensitive information should not be displayed when the computing device is in a public space. As another example, the processor may access information available in a wireless transceiver component to determine whether detected wireless access point indicate the computing device is in a secure location (e.g., by detecting the user's home WIFI router) or in a public space (e.g., by detecting an access point hosted by a business or public facility). As another example, the processor may access a microphone of the computing device and analyze ambient noise to determine whether the computing device is in a public space. Other sensors and sources of information may be accessed and processed by the processor in analyzing the environment in which the computing device is located to determine whether sensitive information should not be displayed.

The processor may then perform the operations of block 506 as described.

FIG. 5C illustrates further operations that may be performed by the processor in the method 500 in some embodiments.

After determining portions of the received information that is sensitive and that sensitive information should not be displayed in block 504, the processor may perform operations including blocking display of sensitive information on the touch-sensitive display with a blank field or placeholder characters in response to determining that sensitive information should not be displayed in block 512. For example, in a display of information received from the information source or memory in block 502, the processor may replace or overwrite sensitive information with “X”, “*”, “_” or similar characters. In some embodiments the blocking or placeholder characters may include a tag or hyperlink that the processor may associated with an audio file containing the text-to-speech output rendition of the blocked sensitive information.

In block 506a, the processor may perform operations including outputting the audio description of the sensitive information via the personal audio output device in response to a user touch on the blank field or placeholder characters. For example, in response to the user of the computing device touching a field of replacement characters (e.g., “XXX,XXX.XX”) rendered on a touch sensitive display, the processor may access an audio file (e.g., via an associated tag or hyperlink) containing the audio description (i.e., text-to-speech application output) of the corresponding sensitive information. In this manner, the computing device only outputs the audio description when the user elects to hear it. This may enable the user to put on the personal audio device, for example.

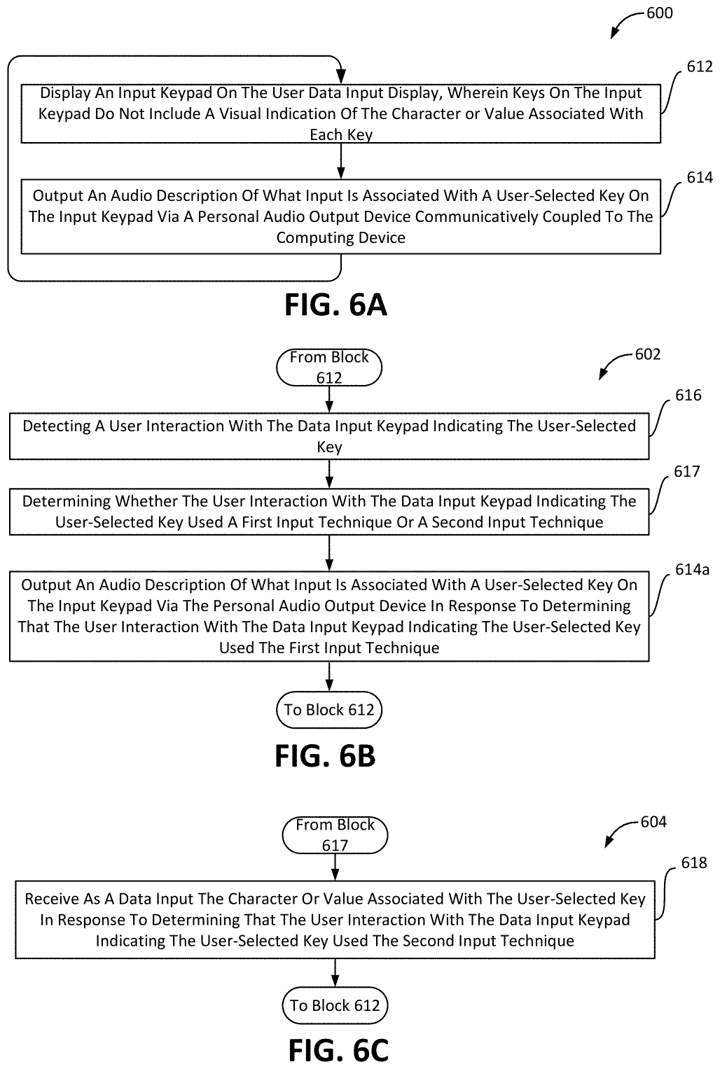

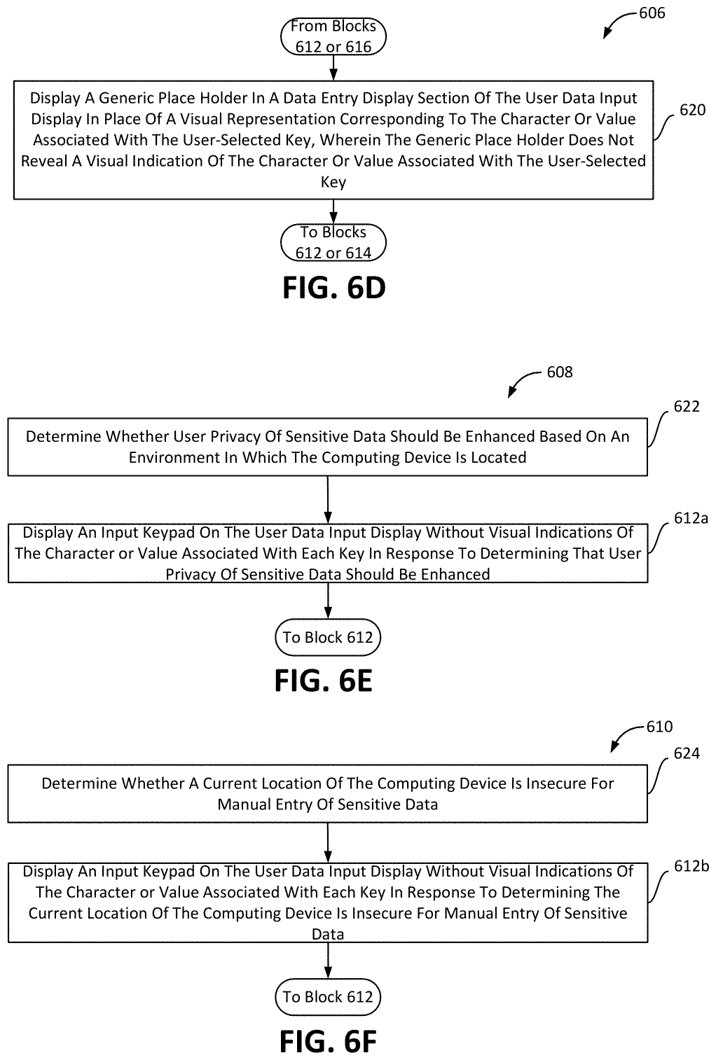

FIGS. 6A, 6B, 6C, 6D, 6E, and/or 6F illustrate operations of methods 600, 602, 604, 606, 608, and 610 for enhancing user privacy of sensitive data on a touch-sensitive display of a computing device in accordance with various embodiments. The operations of the methods 600, 602, 604, 606, 608, and 610 presented below are intended to be illustrative. In some embodiments, method 600 may be accomplished with one or more additional operations not described, and/or without one or more of the operations discussed. Additionally, the order in which the operations of the methods 600, 602, 604, 606, 608, and 610 are illustrated in FIG. 6A, 6B, 6C, 6D, 6E, and/or 6F and described below is not intended to be limiting.

In some embodiments, the methods 600, 602, 604, 606, 608, and 610 may be implemented in one or more processors (e.g., a digital processor, an analog processor, a digital circuit designed to process information, an analog circuit designed to process information, a state machine, and/or other mechanisms for electronically processing information) in response to instructions stored electronically on an electronic storage medium. The one or more processors may include one or more devices configured through hardware, firmware, and/or software to be specifically designed for execution of one or more of the operations of the methods 600, 602, 604, 606, 608, and 610. For example, with reference to FIGS. 1-6F, the operations of the methods 600, 602, 604, 606, 608, and 610 may be performed by a processor of a computing device (e.g., 110).

FIG. 6A illustrates method 600 in accordance with one or more embodiments.

In block 612, the processor may perform operations including displaying a data input keypad on the user data input display, wherein keys on the data input keypad do not include a visual indication of the character or value associated with each key. For example, the data input keypad may include an array of boxes, circles or other key icons with no character or number displayed within each key icon. As another example, the data input keypad may include an array of boxes or key icons with a place keeper character (e.g., #, %, &, or *) displayed within each key icon.

In block 614, the processor may perform operations including outputting an audio description of the character (e.g., a letter) or value (e.g., a digit) associated with a user-selected key of the keys on the data input keypad via a personal audio output device communicatively coupled to the computing device. In some embodiments, the audio output may be in the form of audio data stored in nonvolatile memory that is linked to the associated number or character of the user-selected keys. In some embodiments, the audio output may be generated by a text-to-speech process executing in the processor that uses the number or character associated with a user-selected key as the input and outputs synthesized speech to the audio output device. The output of the audio description of the character or value associated with the user-selected key may be configured to be heard only by the user. Following the operations in block 614, the processor may once again perform the operations in block 612 as described as the user selects another key.

FIG. 6B illustrates a method 602 by which the processor may identify the user-selected key based on user interactions with the data input keypad in accordance with one or more embodiments.

In block 616, following the display of the data input keypad in block 612 in the method 600, the processor may perform operations including detecting a user interaction with the data input keypad indicating the user-selected key. User interactions with the data input keypad on the touch-sensitive display may include, for example, the user touching or tapping a key icon, the user holding a finger on a key icon, the user touching or tapping a stylus on a key icon, and the user hovering a finger or stylus over a key icon. The type of interaction performed by the user that indicates selection of a particular key (i.e., indicating the user-selected key) may vary depending upon the type of touch-sensitive display.

In block 617, the processor may be configured to determine whether the user interaction with the data input keypad used the first key selection technique or the second key selection technique (or fourth, fifth, etc.). In some embodiments, the user interaction with the data input keypad indicating the user-selected key may use or involve two (or more) different types of input techniques that differ from one another sufficient to enable the processor to distinguish a first type of input technique from a second type of input technique. Recognizing when the user has interacted with the data input keypad using a first input technique may indicate to the processor that the processor should (or trigger the processor to) output the audio description of the user-selected key. Recognizing a second input technique may indicate to the processor that the processor should (or trigger the processor to) enter as a data input the character or value associated with the user-selected key. In this manner, by using the two different input techniques, a user may essentially interrogate the keys on the date input keypad to learn their associated characters or values by interacting with keys individually using the first input technique while listening to the audio description of each. Then when the user finds the key associated with the desired character or value, the user may interact with the key using the second input technique to inform the processor that it should enter the associated character or value as a data input. In some embodiments, the user may use a third input technique or a fourth input technique to inform the processor that is should enter a second or third character or value as a data input.

In block 614a, the processor may be further configured to output the audio description of the character or value associated with the user-selected key in block 617 in response to recognizing that the user interacted with the data input keypad using the first key selection technique, and do so without entering the associated character or key as a data input.

The method 602 may be repeated when the user selects another key in block 612 as described.

FIG. 6C illustrates method 604 by which the processor enters a character or value associated with the user-selected key based on user interactions with the data input keypad in accordance with one or more embodiments.

In block 618, following the operations of block 617 in the method 602, the processor may perform operations including receiving or entering as a data input the character or value associated with the user-selected key in response to determining that the user interaction with the data input keypad indicating the user-selected key used the second input technique.

The user may select another key in block 612 of the method 6 as described and the process may repeat while the use enters sensitive data.

FIG. 6D illustrates a method 606 in accordance with one or more embodiments.

In block 620, following the operations of block 612 in the method 600 or block 616 in the method 602, the processor may perform operations including displaying a generic placeholder in a data entry display section of the touch-sensitive display in place of a visual representation corresponding to the character or value associated with the user-selected key. The generic placeholder may not reveal a visual indication of the character or value associated with the user-selected key to an observer of the display. Displaying the generic placeholder in block 620 may be in response to the user touching the user-selected key using the second key selection technique that the processor is configured to recognize as triggering entry of the character or value associated with the user-selected key (e.g., from block 618). Following the operations in block 620, the processor may perform the operations in block 614 as described. Thus, the processor may be configured to provide a user setting for the option to either perform the operations in block 614 following block 620 or perform the operations in block 612 as described.

FIG. 6E illustrates a method 608 for determining whether user data privacy should be enhanced in accordance with one or more embodiments.

In block 622, the processor may perform operations including determining whether user privacy of sensitive data should be enhanced based on an environment in which the computing device is located. For example, the processor may determine that user privacy of sensitive data should be enhanced in response to determining that there are other individuals close by, such as by analyzing audio data captured by a microphone, detecting the presence of other computing devices nearby based on intercepted wireless signals, etc.

In block 612a, the processor may display the keys on the data input keypad without a visual indication of the character or value associated with each key in response to the processor determining that user privacy of sensitive data should be enhanced.

FIG. 6F illustrates a method 610 in accordance with one or more embodiments.

In block 624, the processor may perform operations including determining whether a current location of the computing device is insecure for manual entry of sensitive data. For example, the processor may use the location of the computing device (e.g., determined through a map application or a geopositioning system receiver) to determine whether the computing device is in a location that is known to the computing device (e.g., based upon information stored in a location-indexed data table stored in memory) to be insecure. As another example, the processor may use address or business information from a map application to recognize when the computing device is in a public establishment (e.g., a coffee shop, library, etc.) and determine whether the computing device is in an insecure location based upon the type of public establishment. Other location-based determinations of relative security may be used by the processor in block 624.

In block 612b, the processor may display the keys on the data input keypad without a visual indication of the character or value associated with each key in response to the processor determining that the current location of the computing device is insecure for manual entry of sensitive data.

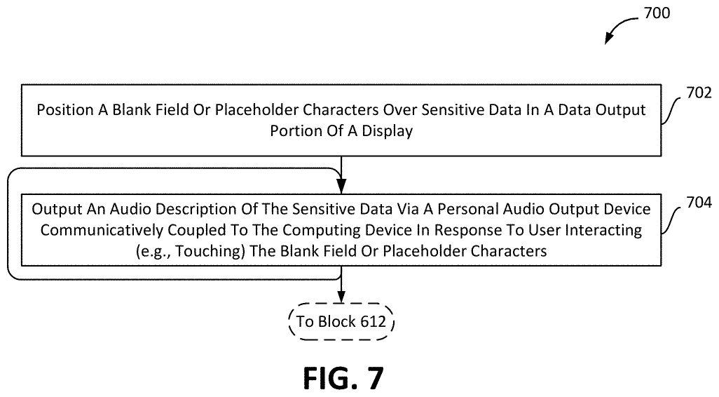

As described with reference to FIG. 1, some embodiments may further secure user sensitive information by preventing display of such information on data output displays while enabling users to learn the information by listening to an audio announcement of the information generated by the processor and output through personal audio device in response to the user touching or otherwise selecting the blank field (e.g., 160) or placeholder characters (e.g., a string of X, *, #, @, $, etc.). FIG. 7 illustrates operations of a method 700 for enhancing user privacy of sensitive data on a user data output display of a computing device in accordance with various embodiments. With reference to FIGS. 1-7, the operations of the method 700 may be performed for any data output display that includes sensitive user information, and may be performed as part of the operations of any of methods 600, 602, 604, 606, 608, and 610 for enhancing user privacy of sensitive data on a touch-sensitive display that also displays sensitive user information (e.g., an account number, user name, account balance, etc.) as illustrated in FIG. 1.

The method 700 may be implemented in one or more processors (e.g., a digital processor, an analog processor, a digital circuit designed to process information, an analog circuit designed to process information, a state machine, and/or other mechanisms for electronically processing information) in response to instructions stored electronically on an electronic storage medium. The one or more processors may include one or more devices configured through hardware, firmware, and/or software to be specifically designed for execution of one or more of the operations of the method 700. For example, the operations of methods 600, 602, 604, 606, 608, and 610 may be performed by a processor of a computing device (e.g., 110).

In block 702, the processor may generate or modify a display of information by positioning a blank field or placeholder characters over sensitive data in a data output portion of a display. In some embodiments, the processor may substitute a blank field or placeholder characters in a location within a generated display where sensitive information would otherwise be rendered. In some embodiments, the processor may analyze a display generated by an application to identify sensitive information, and then modify the display by positioning a blank field or placeholder characters over the identified sensitive information. As part of generating or modifying the display, the processor may also correlate the blank fields and/or placeholder characters with the sensitive data such that the processor can access or obtain the data in response to detecting a user touch on the correlated blank fields and/or placeholder characters. For example, the processor may store the sensitive data in memory linked to or along with touchscreen coordinates of the blank fields of placeholder characters.

In block 704, the processor may respond to detection of a user touching or otherwise selected (e.g., touching with a stylus or “moussing over”) a blank field or placeholder characters by outputting an audio description of the sensitive data via a personal audio output device communicatively coupled to the computing device. In some embodiments, the audio output may be generated by a text-to-speech process executing in the processor that receives the associated sensitive information as the input and outputs synthesized speech to the audio output device.

The operations of block 604 may be repeated each time the user touches or otherwise selects a blank field or placeholder characters. Optionally, the processor may perform the operations of block 612 of the method 600 to output an audio description of a touched user-input display as described with reference to FIG. 6A. Further, the method 700 may be repeated, including positioning blank fields and/or placeholder characters over sensitive data in block 702 as the display changes due to user interactions with the display using the second key-selection technique, such as double tapping a key to enter the character or value associated with the key. For example with reference to FIG. 2C, each time a user actuates a key 135 using the second key-selection technique, the processor may perform the operations of block 702 to substitute or cover over the entered value with a “*”. Then if a user wants to check the entered characters or values, the user can touch or otherwise select the “*” and the processor may perform the operations of block 704 to output an audio announcement of the associated character or value via a user audio device so that only the user can hear annunciation of the associated character or value.

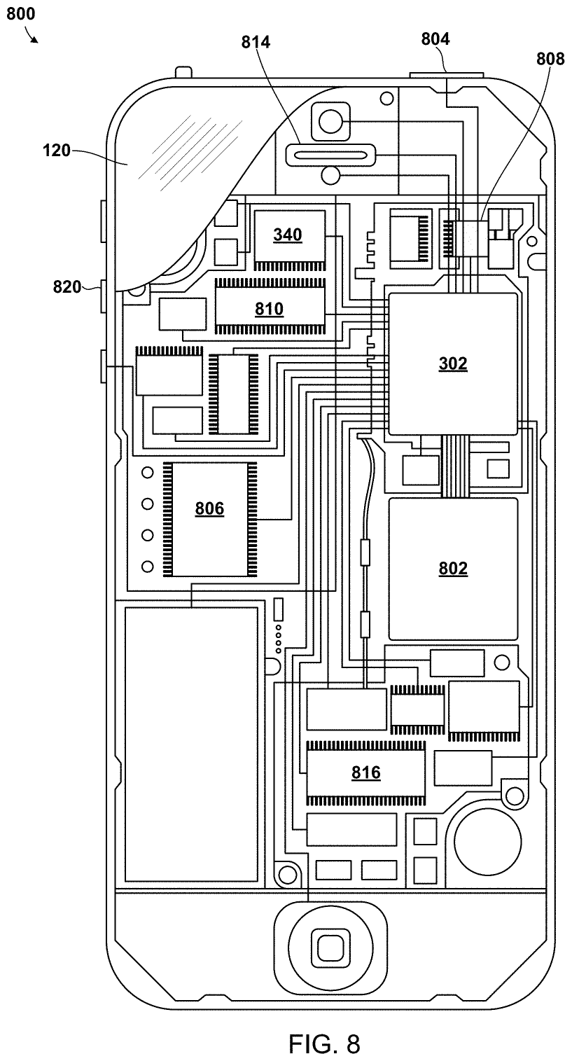

Various embodiments may be implemented on a variety of wireless devices (e.g., the computing device 110), an example of which is illustrated in FIG. 8 in the form of a smartphone 800. The smartphone 800 may include a processor 302 (e.g., an SOC-CPU) coupled to a modem 802 (e.g., a 5G capable modem). The processor SOC 302 may be coupled to internal memory 806, 816, a touch sensitive display 120, a speaker 814 and an audio output interface 340, such as a socket for a headphone jack or a Bluetooth transceiver configured to output audio signals to a personal audio output device (e.g., 150). Additionally, the smartphone 800 may include an antenna 804 for sending and receiving electromagnetic radiation that may be connected to a wireless data link and/or cellular telephone transceiver 808 coupled to one or more processors in the processor SOC 302. Smartphones 800 typically also include menu selection buttons or rocker switches 820 for receiving user inputs.

A typical smartphone 800 also includes a sound encoding/decoding (CODEC) circuit 810, which digitizes sound received from a microphone into data packets suitable for wireless transmission and decodes received sound data packets to generate analog signals that are provided to the speaker to generate sound.

The processors of the smart phone 800 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within a modem SOC 802 dedicated to wireless communication functions and one processor within another SOC 302 dedicated to running other applications. Typically, software applications may be stored in the memory 806, 816 before they are accessed and loaded into a processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of any of the methods 500, 600, 602, 604, 606, 608, 610, and 700 may be substituted for or combined with one or more operations of any of the methods 500, 600, 602, 604, 606, 608, 610 and 700.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A computing device, comprising:
a touch-sensitive display;
an audio output interface configured to output audio signals to a personal audio output device;
a memory; and
a processor coupled to the touch-sensitive display, the audio output interface, and the memory, and configured with processor-executable instructions to perform operations comprising:
receiving information for display from an information source or memory;
determining at least a portion of the received information is sensitive information;
determining an environment in which the computing device is located;
determining whether the sensitive information should not be displayed based on the determined environment; and
outputting an audio description of sensitive information via the personal audio output device in response to determining that the sensitive information should not be displayed based on the determined environment, wherein the output of the sensitive information is configured to be heard only by a user.

2. The computing device of claim 1, wherein the processor is configured with processor-executable instructions to perform operations such that determining whether at least a portion of the received information is sensitive information and whether sensitive information should not be displayed comprises:
determining whether at least a portion of the received information is sensitive information based on one or more of a source of the received information, metadata associated with the received information, a context of the received information, or a content of the received information; and
determining whether sensitive information should not be displayed is based on an environment in which the computing device is located.

3. The computing device of claim 1, wherein the processor is configured with processor-executable instructions to perform operations further comprising:
blocking display of sensitive information on the touch-sensitive display with a blank field or placeholder characters in response to determining that sensitive information should not be displayed; and
outputting the audio description of the sensitive information via the personal audio output device in response to a user touch on the blank field or placeholder characters.

4. The computing device of claim 1, wherein the processor is configured with processor-executable instructions to perform operations further comprising:
displaying a data input keypad on the touch-sensitive display without a visual indication of a character or value associated with each key;
detecting a user interaction with the data input keypad indicating a user-selected key;
determining whether the user interaction with the data input keypad indicating the user-selected key used a first key selection technique or a second key selection technique different from the first key selection technique; and
outputting an audio description of the character or value associated with the user-selected key via the personal audio output device in response to determining that the user interaction with the data input keypad indicating the user-selected key used the first key selection technique, wherein the output of the audio description of the character or value associated with the user-selected key is configured to be heard only by a user.

5. The computing device of claim 4, wherein the processor is configured with processor-executable instructions to perform operations further comprising:
receiving as a data input the character or value associated with the user-selected key in response to determining that the user interaction with the data input keypad indicating the user-selected key used the second key selection technique.

6. The computing device of claim 5, wherein the processor is configured with processor-executable instructions to perform operations such that the first key selection technique is a single-tap or touch of the user-selected key and the second key selection technique is a double-tap or touch of the user-selected key.

7. The computing device of claim 5, wherein the processor is configured with processor-executable instructions to perform operations further comprising:
displaying a generic placeholder in a data entry display section of the touch-sensitive display in place of a visual representation of the character or value associated with the user-selected key in response to entering the character or value associated with the user-selected key,
wherein displaying the generic placeholder is performed in response to the user touching the user-selected key using a key selection technique configured to enter as an input selection the character or value associated with the user-selected key.

8. The computing device of claim 4, wherein the processor is configured with processor-executable instructions to perform operations such that the output of the audio description of the character or value associated with the user-selected key provides the only feedback of a value or character associated with the user-selected key.

9. The computing device of claim 4, wherein the processor is configured with processor-executable instructions to perform operations such that the output audio description of the character or value associated with the user-selected key includes an audio description of more than one character or value associated with the user-selected key.

10. The computing device of claim 4, wherein the processor is configured with processor-executable instructions to perform operations further comprising randomly assigning a character or value associated with each key on the data input keypad each time the data input keypad is displayed.

11. The computing device of claim 4, wherein the processor is configured with processor-executable instructions to perform operations further comprising assigning the character or value associated with each key on the data input keypad based on user inputs in a configuration process.

12. The computing device of claim 4, wherein the processor is configured with processor-executable instructions to perform operations further comprising:
determining whether user privacy of sensitive data should be enhanced based on the environment in which the computing device is located; and
displaying the keys on the data input keypad without the visual indication of the character or value associated with each key in response to determining that user privacy of sensitive data should be enhanced.

13. The computing device of claim 4, wherein the processor is configured with processor-executable instructions to perform operations further comprising:
determining whether a current location of the computing device is insecure for manual entry of sensitive data; and
displaying the keys on the data input keypad without the visual indication of the character or value associated with each key in response to determining the current location of the computing device is insecure for manual entry of sensitive data.

14. A method performed by a processor of a computing device for protecting sensitive data entered on a touch-sensitive display of the computing device, comprising:
receiving information for display from an information source or memory;
determining at least a portion of the received information is sensitive information;
determining an environment in which the computing device is located;
determining whether the sensitive information should not be displayed based on the determined environment; and
outputting an audio description of sensitive information via a personal audio output device communicatively coupled to the computing device in response to determining that the sensitive information should not be displayed based on the determined environment, wherein output of the audio description of the sensitive information is configured to be heard only by a user.

15. The method of claim 14, wherein determining whether at least a portion of the received information is sensitive information and whether sensitive information should not be displayed comprises:
determining whether at least a portion of the received information is sensitive information based on one or more of a source of the received information, metadata associated with the received information, a context of the received information, or a content of the received information; and
determining whether sensitive information should not be displayed is based on an environment in which the computing device is located.

16. The method of claim 14, further comprising:
blocking display of sensitive information on the touch-sensitive display with a blank field or placeholder characters in response to determining that sensitive information should not be displayed; and
outputting the audio description of the sensitive information via the personal audio output device in response to a user touch on the blank field or placeholder characters.

17. The method of claim 14, further comprising:
displaying a data input keypad on the touch-sensitive display without a visual indication of a character or value associated with each key;
detecting a user interaction with the data input keypad indicating a user-selected key;
determining whether the user interaction with the data input keypad indicating the user-selected key used a first key selection technique or a second key selection technique different from the first key selection technique; and
outputting via the personal audio output device an audio description of the character or value associated with the user-selected key in response to determining that the user interaction with the data input keypad indicating the user-selected key used the first key selection technique, wherein output of the audio description of the character or value associated with the user-selected key is configured to be heard only by a user.

18. The method of claim 17, further comprising:
receiving in the processor as a data input the character or value associated with the user-selected key in response to determining that the user interaction with the data input keypad indicating the user-selected key used the second key selection technique.

19. The method of claim 18, wherein the first key selection technique is a single-tap or touch of the user-selected key and the second key selection technique is a double-tap or touch of the user-selected key.

20. The method of claim 18, further comprising:
displaying a generic placeholder in a data entry display section of the touch-sensitive display in place of a visual representation of the character or value associated with the user-selected key in response to entering the character or value associated with the user-selected key,
wherein displaying the generic placeholder is performed in response to the user touching the user-selected key using a key selection technique configured to enter as an input selection the character or value associated with the user-selected key.

21. The method of claim 17, wherein output of the audio description of the character or value associated with the user-selected key provides the only feedback of a value or character associated with the user-selected key.

22. The method of claim 17, wherein output audio description of the character or value associated with the user-selected key includes an audio description of more than one character or value associated with the user-selected key.

23. The method of claim 17, further comprising the processor randomly assigning a character or value associated with each key on the data input keypad each time the data input keypad is displayed.

24. The method of claim 17, further comprising assigning the character or value associated with each key on the data input keypad based on user inputs in a configuration process.

25. The method of claim 17, further comprising:
determining, by the processor, whether user privacy of sensitive data should be enhanced based on the environment in which the computing device is located, wherein displaying the keys on the data input keypad without the visual indication of the character or value associated with each key is performed in response to determining that user privacy of sensitive data should be enhanced.

26. The method of claim 17, further comprising:
determining, by the processor, whether a current location of the computing device is insecure for manual entry of sensitive data, wherein displaying the keys on the data input keypad without the visual indication of the character or value associated with each key is in response to determining the current location of the computing device is insecure for manual entry of sensitive data.

27. A non-transitory processor-readable medium having stored thereon processor-executable instructions configured to cause a processor of a computing device to perform operations comprising:
receiving information for display from an information source or memory;
determining at least a portion of the received information is sensitive information;
determining an environment in which the computing device is located;
determining whether the sensitive information should not be displayed based on the determined environment; and
outputting an audio description of sensitive information via a personal audio output device communicatively coupled to the computing device in response to determining that the sensitive information should not be displayed based on the determined environment, wherein output of the audio description of the sensitive information is configured to be heard only by a user.

28. The non-transitory processor-readable medium of claim 27, wherein the stored processor-executable instructions are configured to cause the processor of the computing device to perform operations further comprising:
blocking display of sensitive information on a touch-sensitive display with a blank field or placeholder characters in response to determining that sensitive information should not be displayed; and
outputting the audio description of sensitive information via the personal audio output device in response to a user touch on the blank field or placeholder characters.

29. The non-transitory processor-readable medium of claim 27, wherein the stored processor-executable instructions are configured to cause the processor of the computing device to perform operations further comprising:
displaying a data input keypad on the touch-sensitive display without a visual indication of a character or value associated with each key;
detecting a user interaction with the data input keypad indicating a user-selected key;
determining whether the user interaction with the data input keypad indicating the user-selected key used a first key selection technique or a second key selection technique different from the first key selection technique;
outputting via the personal audio output device an audio description of the character or value associated with the user-selected key in response to determining that the user interaction with the data input keypad indicating the user-selected key used the first key selection technique, wherein output of the audio description of the character or value associated with the user-selected key is configured to be heard only by a user; and
receiving in the processor as a data input the character or value associated with the user-selected key in response to determining that the user interaction with the data input keypad indicating the user-selected key used the second key selection technique.

30. A computing device, comprising:
a touch-sensitive display;
means for receiving information for display from an information source or memory;
means for determining at least a portion of the received information is sensitive information;
means for determining an environment in which the computing device is located;
means for determining whether the sensitive information should not be displayed based on the determined environment; and
means for outputting an audio description of sensitive information via a personal audio output device communicatively coupled to the computing device in response to determining that the sensitive information should not be displayed based on the determined environment, wherein output of the audio description of the sensitive information is configured to be heard only by a user.
